(19) United States
(12) Patent Application Publication
(10) Pub. No.: US 2008/0079582 A1
(43) Pub. Date: Apr. 3, 2008

(54) ELECTRONIC ARTICLE SURVEILLANCE ENABLED RADIO FREQUENCY IDENTIFICATION SYSTEM AND METHOD

(75) Inventors: Mark ALEXIS, Wellington, FL (US); Gary Mark SHAFER, Boca Raton, FL (US)

Correspondence Address: Christopher & Weisberg, P.A., 200 East Las Olas Boulevard, Suite 2040, Fort Lauderdale, FL, 33301, US

(73) Assignee: SENSORMATIC ELECTRONICS CORPORATION, Boca Raton, FL (US)

(21) Appl. No.: 11/760,851

(22) Filed: Jun. 11, 2007

Related U.S. Application Data
(60) Provisional application No. 60/848,215, filed on Sep. 28, 2006.

(51) Int. Cl. G08B 13/14

(52) U.S. Cl. 340/572.1

(57) ABSTRACT

A method and system for exchanging data between one or more RFID readers and one or more EAS system devices in an RFID system using RFID air interface protocol. An RFID system includes one or more EAS system devices in data communication with one or more RFID readers over an interrogation zone. EAS system devices utilize RFID air interface protocol to transmit wireless data signals, which may include alarm event data, to the RFID readers, obviating the need to implement a separate communication infrastructure. The RFID readers may forward the alarm event data to an RFID backscatter enabled host computer for processing the received signals. The host computer may then schedule further interrogation of inventory items at locations where an alarm event has occurred. One or more multiplexers may facilitate the data exchange between RFID readers and the EAS system devices in order to provide an even more robust communication network.

### CROSS-REFERENCE TO RELATED APPLICATION

This application is related to and claims priority to U.S. Provisional Patent Application Ser. No. 60/848,215, filed Sep. 28, 2006, entitled US Provisional Patent for ELECTRONIC ARTICLE SURVEILLANCE ENABLED RADIO FREQUENCY IDENTIFICATION MULTIPLEXER AND METHOD, the entirety of which is incorporated herein by reference.

### STATEMENT REGARDING FEDERALLY SPONSORED RESEARCH OR DEVELOPMENT

n/a

### FIELD OF THE INVENTION

The present invention relates to radio frequency identification (“RFID”) communications and electronic article surveillance (“EAS”), and in particular to an RFID network that supports EAS and alarm systems.

### BACKGROUND OF THE INVENTION

RFID systems are used in many different applications, including for example in retail environments to obtain information relating to items tagged with RFID identifiers. For example, an RFID tag can be attached or integrated within a product or product packaging. Using an RFID interrogator (also referred to herein as an “RFID reader”), which may be a fixed, portable or handheld device, RFID tags within the interrogation zone of the interrogator may be activated and provide information regarding the item associated with the RFID tag (e.g., product descriptor, serial number, location, etc.). These RFID tags receive and respond to radio frequency (“RF”) signals to provide information, for example, related to the product to which the RFID tag is attached. This is typically accomplished using a standard air interface protocol such as the Electronic Product Code (“EPC”) Radio Frequency Identity Protocol. Such information may include inventory information relating to items on a shelf or items in a warehouse. In general, modulators within the RFID tags may transmit back a signal using a transmitter or reflect back a signal to the RFID readers. This transmitted/reflected signal is referred to as a backscatter signal. Additionally, information may be communicated to the RFID tags (e.g., encoding information) using RFID encoders. Thus, RFID systems are typically used to monitor the inventory of products in a retail environment and provide product identification using the storage and remote retrieval of data using RFID tags or transponders.

In addition, certain RFID applications use a reader to connect to multiple antennas through a multiplexer (“MUX”). For example, in a retail environment using an RFID system to track inventory, it is known to provide numerous read points that each include the use of RF multiplexers and numerous cables to connect to each read point. In this context, the MUX routes RFID signals, i.e., RF signals, to multiple antennas based on digital logic inputs from a controller. The MUX and the antennas coupled to the MUX are typically used to extend the range of a reader to be able to send commands and/or data to tags and to receive backscatter signals containing responses and/or data from the tags. One example is an RFID network in which RFID tagged merchandise is placed on shelves having multiple antennas all connected to a central reader. Such a network provides a long term inventory of items on the shelves. However, in such a network having multiple antennas, numerous wires and cables must be connected to the MUX in order to route the control, RF signals and alternating current/direct current (AC/DC) power necessary for network functionality. These MUXes can be located in areas which also support EAS and alarm systems. Accordingly, it is desirable to be able to extend the use of the MUXes to support uses beyond RFID inventory control.

These same customers also have a need for other communications. For example a customer who has an RFID system for inventory management may also have a security monitoring (alarm) system, or at least have a need for one. This typically requires an installation of cameras, photo-infrared detectors, sensors, etc., that must be wired communicate by a wireless communication system with a monitoring station or alarm panel. This communication infrastructure is separate from the infrastructure used for the RFID system. Customers may also have or have a need for an EAS system. EAS systems protect assets and merchandise by utilizing security tags and labels, and EAS detection equipment. EAS systems provide security for buildings, entrances, exits and enclosed areas by triggering an alarm event when items protected with an activated EAS tag or EAS label pass through the EAS detection equipment. Multiple types of EAS labels exist, for example acousto-magnetic and electromagnetic.

Systems such as alarm and EAS systems typically include their own communication network that is separate from the RFID system. Alarm and EAS systems can be wired installations or wireless, the latter increasingly being based on Institute of Electrical and Electronic Engineers (“IEEE”) 802.11 standards. This is the case whether an existing alarm or EAS system is being expanded or whether an alarm or EAS system is being newly installed in a location that has or will simultaneously have an RFID system for inventory control. The result is wasted time and money due to the installation of networking equipment to support the RFID system and the alarm and/or the EAS system. It is desirable, therefore, to have a method and system that allows the networking and communication capability of the RFID system to support and inter-operate with EAS and alarm systems.

### SUMMARY OF THE INVENTION

The present invention advantageously provides a method and system for communication between one or more RFID readers and one or more EAS system devices in an RFID network using RFID interface protocol. The method and system disclosed herein uses the radio frequency spectrum and RFID communication protocol to allow data communication between an RFID reader and one or more EAS system devices, such as, for example, sensors or alarms. These EAS system devices appear as RFID-tags to the RFID reader, even though the data exchanged is EAS system-related data. Thus, network communications between RFID readers and EAS system devices can occur without the need for additional installation and/over overhead costs.

In one embodiment, a method for using an RFID system to support data communications for an electronic article surveillance system is provided. The method includes receiving EAS data from one or more EAS system devices, where the EAS data representing an EAS event, transmitting the EAS data from a first RFID system device to a second RFID system device using an RFID air interface protocol, and processing the EAS data.

In another embodiment, an RFID system for supporting data communications with an electronic article surveillance system is provided. The system includes one or more RFID readers in data communication with one or more EAS system devices, where the one or more RFID readers communicate with the EAS system devices via RFID air interface protocol.

In still another embodiment, an RFID multiplexer is provided. The RFID multiplexer includes a microcontroller used to control the operation of multiplexer, where the microcontroller interrogates the one or more EAS system devices in order to obtain information, and a storage unit for storing the information relating to the EAS system devices.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein like designations refer to like elements, and wherein:

FIG. 1 is a block diagram of a system constructed in accordance with the principles of the present invention;

FIG. 2 is a block diagram of an RFID multiplexer constructed in accordance with the principles of the present invention; and

FIG. 3 is a block diagram of an alternate embodiment of the present invention.

### DETAILED DESCRIPTION OF THE INVENTION

In accordance with one aspect, system 10 utilizes an RFID multiplexer in a manner that allows it to be used in conjunction with EAS or other security alarm system devices that provide data input, e.g., door sensors, PIR sensors, intrusion alarms, access control, etc. during a “sensor event”. The multiplexer monitors data inputs from these EAS and alarm system data generating devices, i.e., the sensors, alarms, etc., and stores their activity (state changes, alarms, etc) until an RFID reader accesses the multiplexer during a normal RFID inventory process (such as shelf reading or portal monitoring). At this time, these sensor events will be encoded as RFID IDs and or RFID IDs and data (such as EPC Gen2) and returned to the RFID reader as normal RFID “singulations”. The term “singulation” refers to the identification by an RFID reader of a tag with a specific serial number from a number of tags in its interrogation field. The reader can then pass the sensor event data on to the enterprise system monitoring the facility.

It is contemplated that the multiplexer can be equipped with logic rules and outputs to trigger other devices in when certain alarms occur. For example, this output could be used to trigger the RFID reader to perform an inventory at the location of the alarm event.

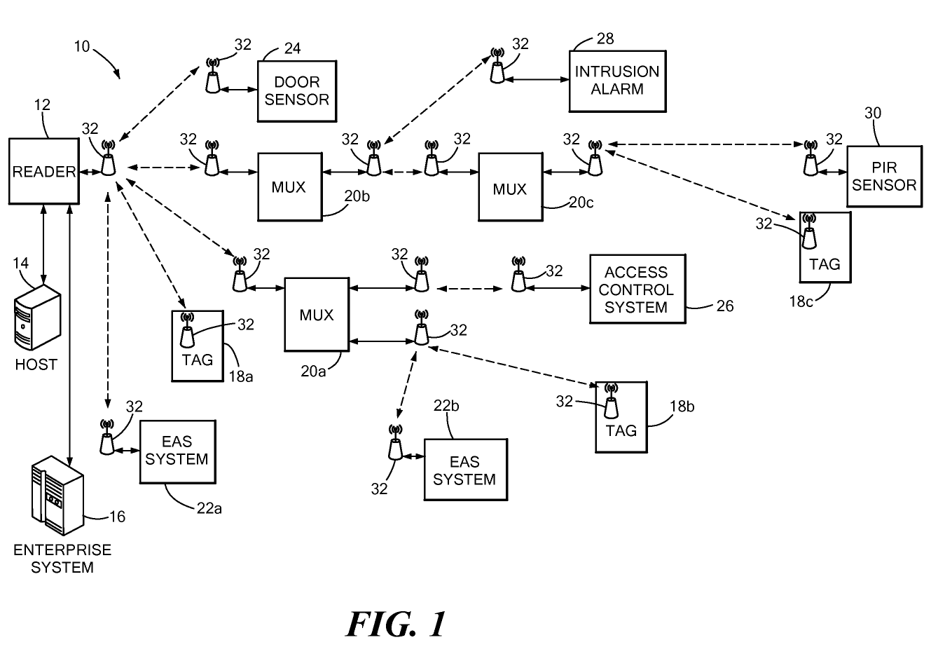

Referring now to the drawing figures in which like reference designators refer to like elements, there is shown in FIG. 1 a diagram of an exemplary system constructed in accordance with the principles of the present invention and designated generally as “10”. System 10 includes one or more readers 12 in communication with an RFID host computer 14. Reader 12 exchanges data with a host computer 14 as may be necessary, e.g., to perform inventory control. In this case host computer 14 includes the databases used to track and maintain the inventory. Host computer 14, as described below, also includes those components, e.g., memory, CPU, I/O, display, etc., to track the communication and hierarchical relationship between the other devices in system 10, e.g., MUXes, tags, non-tag devices, and the like. This allows an operator to understand how the components are interconnected and also allows system components, to be used with specificity, e.g., updating pricing on a shelf reader visual display associated with a particular type of item or even receiving image data from a particular camera if a particular sensor is tripped.

In addition to or instead of host computer 14, reader 12 can interface with and exchange data with enterprise system 16. This interface provides communication via a hard wired or wireless communication networked or direct connection. Enterprise system 16 can be a single computing device such as host computer 14, or can include multiple networked computing devices, display, input devices, etc. as may be used in conjunction with an EAS or security alarm monitoring system.

System 10 includes traditional RFID tags 18a-c (referred to collectively herein as “tags 18”) and MUXes 20a-c (referred to collectively herein as “MUXes 20”). Of note, although enterprise system 16 is shown in FIG. 1 as coupled to reader 12, the present invention is not limited to such. It is contemplated that enterprise system 16 can be in direct communication with one or more MUXes 20.

System 10 also includes devices found in EAS and alarm systems, including but not limited to EAS systems 22a and 22b (referred to collectively herein as “EAS systems 22”), door sensor 24, access control system 26, intrusion alarm 28 and photo-infrared (“PIR”) sensor 30. Of note, devices 22-30 are merely exemplary and it is presumed that one of ordinary skill would understand that there are many other types of EAS and alarm system elements that can be supported by the present invention. Also, the quantities of tags 18, MUXes 20 and devices 22-30 shown in FIG. 1 are purely exemplary and a system 10 can include differing amounts, if any, of a particular one of these elements.

The reader 12, MUXes 20, tags 18 and EAS/alarm system devices 22-30 communicate wirelessly using backscatter with one another using antennas 32. Of note, although some elements, such as tags 18, show antenna 32 within the device, this arrangement is merely exemplary. It is contemplated that an antenna 32 can be incorporated within, or externally coupled to the reader 12, MUXes 20, tags 18 and EAS/alarm system devices 22-30.

Of note, although FIG. 1 shows that all devices are in direct or indirect wireless communication with reader 12, the present invention is not limited to such. It is contemplated that one or more devices, e.g., a MUX 20, can be connected to reader 12 in a wired fashion.

This present invention advantageously allows the transmission of typical tag data and a variety of EAS and alarm system data to share the same RFID transmission network and be sent wirelessly by extending an existing RFID air interface protocol such as the Electronic Product Code (“EPC”) Radio Frequency Identity Protocols. The method and system of the present invention use the radio frequency spectrum and protocol transmitted to/from RFID interrogator 12 (note that the terms “reader” and “interrogator” are used interchangeably herein) as the medium for network communication. The communicating devices use the standard protocols to transmit, receive and decode the RFID packets, but the data within the packets need not simply be data and commands related to tag identification and control. Put another way, MUXes 20 and EAS/alarm system devices 22-30 appear to the RFID readers, transmitters and receivers as tags 18, even though the data and/or commands relating to the MUXes 20 and non-tag devices 20 is not tag-related data. This extends traditional tag identifying/writing/reading to allow more robust communications with RFID multiplexers 16 and EAS/alarm system devices 22-30. This arrangement also advantageously eliminates or reduces cabling, networking and installation costs normally required for the interconnection of EAS/alarm system devices 22-30.

In accordance with another aspect, a MUX 20 used to inventory tags 18 within its interrogation zone may need to store and forward that inventory information back to host 14 via reader 12. In such a case, MUX 20 includes elements needed to act as a readpoint (it is noted that other non-tag devices 22-30 can also include reader elements to act as RFID read points) to store and forward tag or EAS system/alarm device information.

For example, MUX 20a can be used to detect and read alarm event data from EAS system 22b. Data corresponding to the alarm event is read from EAS system 22b via the RFID air interface protocol and is stored in MUX 20a. In other words, EAS system 22b appears as a tag to MUX 20a. In turn, when main reader 12 interrogates devices in its interrogation zone, MUX 20a appears as a tag. When interrogated further, main reader 12 learns not only of MUX 20a, but also of any tags, RFID enabled EAS/alarm system devices and other MUXes 20 in its interrogation zone, it also receives the alarm event data initially acquired by EAS system 22b. In this manner, reader 12 can supply enterprise system 16 with the alarm event data that can be further processed. For example, enterprise system 16 might directly or indirectly instruct reader 12 to initiate an inventory of all RFID tags in the area supported by EAS system 22b in order to determine which item triggered the EAS system alarm.

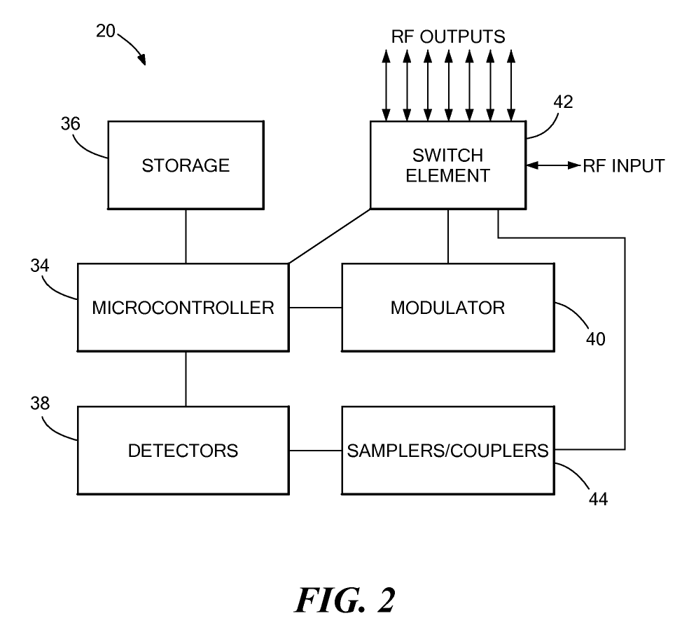

FIG. 2 is a block diagram of an exemplary MUX 20 constructed in accordance with the principles of the present invention as may be used to support the functions described herein. MUX 20 includes microcontroller 34 used to control the operation of MUX 20. Storage unit 36, RF detectors 38, RF modulator 40 and switch element 42 are in electrical communication with microcontroller 34. Samplers and couplers 44 that may be needed are in electrical communication with one or more of the detectors 38. In operation, MUX operating code and data are stored in storage device 36 which can include volatile and/or non-volatile storage areas. Modulator 40 is used to modulate a baseband signal onto an RF carrier for transmission via switch element 42. Detectors 38 and samplers/couplers 44 operate together to detect and extract the baseband signal and command and block data from a received RF signal, such as a signal complying with the EPC air interface standard. Switch element 42 is controlled by microcontroller 34 to switch the input to one of the output lines. Of note, although FIG. 2 shows a microcontroller controlled MUX 20, it is contemplated that the switch element 42 can be controlled by a less intelligent logic circuit.

In addition, although not shown, it is also contemplated that MUX 20 can include one or more other types of interfaces to directly communicate with EAS and alarm system devices. For example, some devices 22-30 might be close enough to a MUX 20 to warrant a direct wired connection via an Ethernet or serial interface. As such, it is contemplated that MUX 20 can include other types of communication interfaces to control and exchange data with EAS and alarm system devices.

Referring again to FIG. 1, although FIG. 1 includes MUXes 20, it is not required that all communications between devices, e.g., EAS system and alarm system devices 22-30 occur through a MUX 20. It is contemplated that reader 12 can act as a communication bridge between devices, e.g., door sensor 24 and enterprise system 16 and/or EAS system 22a.

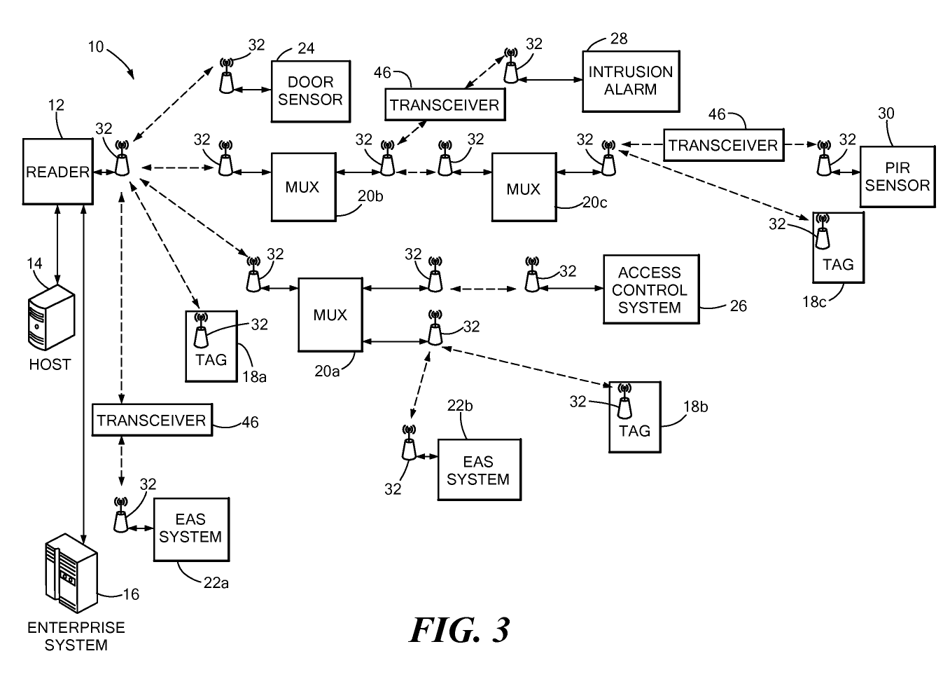

Referring now to FIG. 3, if an EAS/alarm system device 22-30 is not natively equipped with the capability to support RFID communications, it is contemplated that a separate transceiver unit 46 can serve as the interface between the devices 22-30 and antenna 32 that supports RFID backscatter communications as described herein. For example, the separate unit 46 may use a USB or other serial or parallel communications link to interface with the devices 22-30. The separate transceiver unit 46 can then create and store/buffer the data blocks and respond to RFID interrogation signals.

An advantage of the present invention is that, although certain aspects of implementing the present invention may require software customization, existing RFID reader hardware can generally be used in conjunction with the present invention. Once the EAS or alarm system data has been stripped from the RFID singulation, the data can be passed to enterprise system 16 for further processing/action.

In addition, data relating to inventory items can now be associated (in time, location, etc.) with events such as EAS alarms, door openings, movement of people, video triggered alarms, etc. As such, a single enterprise system 16 could easily associate the movement and location of inventory items with alarm events within the same database structure, using RFID readers as a single source of data about the enterprise.

As noted above, a normal inventory process could alter its behavior when an alarm “item” is detected at a node of a MUX 20. For example, when an EAS alarm is detected, a more focused inventory could be executed at the location of the EAS system to detect the items passing thru the EAS system. In other words, the present invention allows inventory data and event data to be captured and analyzed together to enhance loss preventions schemes.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for using an RFID system to support data communications for an electronic article surveillance (EAS) system, the method comprising:
receiving EAS data from one or more EAS system devices, the EAS data representing an EAS event;
transmitting the EAS data from a first RFID system device to a second RFID system device using an RFID air interface protocol; and
processing the EAS data.

2. The method of claim 1, wherein one of the first RFID system device and the second RFID system device is an RFID backscatter-enabled host computer.

3. The method of claim 1, wherein one of the first RFID system device and the second RFID system device is an enterprise system that monitors communication within the RFID system.

4. The method of claim 1, wherein one of the first RFID system device and the second RFID system device is a multiplexer.

5. The method of claim 4, wherein the multiplexer appears to one or more of the first RFID system device and the second RFID system device as an RFID tag.

6. The method of claim 1, further comprising performing an inventory at a location associated with the EAS event.

7. The method of claim 1, wherein one of the first RFID system device and the second RFID system device is an RFID reader and the one or more EAS system devices appear to the RFID reader as an RFID tag.

8. The method of claim 7 further comprising providing a transceiver module to facilitate RFID air interface protocol communication between the one or more EAS devices and the RFID reader.

9. The method of claim 2, wherein at least one of the first RFID system device and the second RFID system device is a parent readpoint device, the method further comprising:
reading information from the one or more EAS system devices; and
transmitting the information from the parent readpoint device to the RFID backscatter enabled host computer using the RFID air interface protocol.

10. The method of claim 3, wherein at least one of the first RFID system and the second RFID system device is a parent readpoint device, the method further comprising:
reading information from the EAS system device; and
transmitting the information from the parent readpoint device to the enterprise system using the RFID air interface protocol.

11. The method of claim 10, wherein the information includes EAS alarm event data.

12. The method of claim 11, further comprising:
extracting the EAS alarm event data from the information; and
associating inventory item data with the extracted EAS alarm event data.

13. The method of claim 12, further comprising instructing one of the first RFID system device and the second RFID system device to initiate an inventory of all RFID system devices based on the EAS alarm event data.

14. An RFID system for supporting data communications with an electronic article surveillance system, the system comprising:
one or more RFID readers in data communication with one or more EAS system devices, wherein the one or more RFID readers communicate with the EAS system devices via an RFID air interface protocol.

15. The system of claim 14, further comprising an RFID backscatter-enabled host computer.

16. The system of claim 15, further comprising an enterprise system that monitors communication within the RFID system.

17. The system of claim 16, further comprising one or more RFID multiplexers in communication with the one or more EAS system devices.

18. The system of claim 17 wherein the each multiplexer appears to the one or more RFID readers as an RFID tag.

19. The system of claim 14, wherein the each EAS system device appears to the one or more RFID readers as an RFID tag.

20. The system of claim 14 further comprising a transceiver module to facilitate RFID air interface protocol communication between the one or more EAS devices and the one or more RFID readers.

21. The system of claim 17, wherein at least one of the one or more multiplexers is a parent readpoint device, wherein the one or more multiplexers read information from the EAS system devices and transmit the information to the RFID backscatter enabled host computer using the RFID air interface protocol.

22. The system of claim 17, wherein at least one of the one or more multiplexers is a parent readpoint device, wherein the one or more multiplexers read information from the EAS system devices and transmit the information to the enterprise system using the RFID air interface protocol.

23. The system of claim 22, wherein the information includes EAS alarm event data.

24. The system of claim 23, wherein the enterprise system extracts the EAS alarm event data from the information, and associates inventory item data with the EAS alarm event data.

25. An RFID multiplexer, comprising:
a microcontroller controlling the operation of the multiplexer, the microcontroller interrogating the one or more EAS system devices in order to obtain information; and
a storage unit for storing the information relating to the EAS system devices.
